(19) United States
(12) Patent Application Publication
(10) Pub. No.: US 2024/0026135 A1
(43) Pub. Date: Jan. 25, 2024

(54) ETHYLENE-VINYL ALCOHOL COPOLYMER COMPOSITION AND PREPARATION METHOD THEREFOR

(71) Applicants: CHINA PETROLEUM & CHEMICAL CORPORATION, Beijing (CN); SINOPEC CHONGQING SVW CHEMICAL CO., LTD., Chongqing (CN)

(72) Inventors: Yuqin DOU, Chongqing (CN); Qingquan WANG, Chongqing (CN); Lamei HU, Chongqing (CN); Lingzhi HE, Chongqing (CN); Yingbin HUANG, Chongqing (CN); Wen WANG, Chongqing (CN); Siquan WAN, Chongqing (CN)

(73) Assignees: CHINA PETROLEUM & CHEMICAL CORPORATION, Beijing (CN); SINOPEC CHONGQING SVW CHEMICAL CO., LTD., Chongqing (CN)

(21) Appl. No.: 18/248,802

(22) PCT Filed: Oct. 14, 2021
(86) PCT No.: PCT/CN2021/123864

§ 371 Date: Apr. 12, 2023

(30) Foreign Application Priority Data
Oct. 15, 2020 (CN) 202011103188.4

(51) Int. Cl. C08L 23/08; C08K 5/09; C08K 3/38; C08K 3/32; C08J 3/12

(52) U.S. Cl. CPC C08L 23/0846; C08K 5/09; C08K 3/38; C08K 3/32; C08J 3/12; C08J 2323/08; C08K 2003/329

(57) ABSTRACT

Provided are an ethylene-vinyl alcohol copolymer composition and a preparation method therefor. The composition includes an ethylene-vinyl alcohol copolymer, an alkali metal element and a carboxyl-containing material, characterized in that the carboxyl-containing material includes a mono-saturated carboxylic acid and a carboxylic acid containing a carbon-carbon double bond. The present invention can improve the yellowing resistance of an EVOH resin composition by making the EVOH resin composition contain both acetic acid and a carboxylic acid containing a carbon-carbon double bond. After heat treatment at 210° C. for 0.5 h, the yellowing index YI does not exceed 20 and the increase does not exceed 15.

### CROSS REFERENCE TO RELATED APPLICATIONS

The present application claims benefit of the Chinese patent application No. “202011103188.4”, filed on Oct. 15, 2020, the content of which is entirely incorporated herein by reference.

### TECHNICAL FIELD

The present invention involves with an ethylene-vinyl alcohol copolymer composition and a preparation method therefor.

### BACKGROUND ART

EVOH resins have excellent odor barrier properties, transparency and glossiness, and are resistant to grease, chemicals, ultraviolet light and other radiation rays, and exhibit desirable mechanical properties, strength and tensile modulus, thus can be used as composite packaging films, foaming processes, hollow containers and barrier layers for meat, grease, industrial solvents, pesticides and the like. In addition, the EVOH resins may be compounded with other materials to form the fire-resistant, antibacterial and anti-oxidant materials.

However, the EVOH resins are prone to cause yellowing during melt processing, thus the product quality is influenced.

CN109651557A improves the alcoholysis degree by adding a base catalyst twice for the alcoholysis reaction and controlling dosage of base catalyst added twice for the alcoholysis reaction and the reaction time, thereby reducing the pigment degree of EVOH, the prepared ethylene-vinyl alcohol copolymer has the alcoholysis degree within a range of 99.3-99.7% and a low pigment degree.

### SUMMARY OF THE INVENTION

The invention aims to overcome the defect in the prior art that the EVOH resin composition is prone to yellowing under the high temperature, thereby provide an EVOH resin composition having a higher yellowing resistance and a preparation method therefor.

According to a first aspect, the invention provides an ethylene-vinyl alcohol copolymer composition, the composition includes an ethylene-vinyl alcohol copolymer, an alkali metal element and a carboxyl-containing material, characterized in that the carboxyl-containing material includes a mono-saturated carboxylic acid and a carboxylic acid containing a carbon-carbon double bond.

According to a second aspect, the invention provides a preparation method of the ethylene-vinyl alcohol copolymer composition, the method comprises subjecting the ethylene-vinyl acetate copolymer obtained from the polymerization reaction to an alcoholysis with an alkali metal hydroxide and molding granulation, followed by a water scrubbing and an acid pickling sequentially, characterized in that the acid used in the acid pickling comprises a mono-saturated carboxylic acid and a carboxylic acid containing a carbon-carbon double bond.

The present invention can improve the yellowing resistance of an EVOH resin composition by making the EVOH resin composition contain both a mono-saturated carboxylic acid such as acetic acid and a carboxylic acid containing a carbon-carbon double bond. After heat treatment at 210° C. for 0.5 h, the yellowing index YI does not exceed 20 and the increase does not exceed 15.

The preparation process of the EVOH resin composition provided by the present invention is simple and easy to operate, it is conducive to the industrial production.

### DESCRIPTION OF THE PREFERRED EMBODIMENT

The ethylene-vinyl alcohol copolymer composition, comprising ethylene-vinyl alcohol copolymer as the main ingredient, is obtained by alcoholysis after copolymerization of the ethylene-vinyl acetate; wherein the element sodium is brought from a byproduct produced during alcoholysis of ethylene-vinyl acetate copolymer, the content of element sodium is usually reduced by the subsequent process of water scrubbing and acid pickling. The acid used for the acid pickling is generally acetic acid at present.

The present inventors have surprisingly discovered that by using both a mono-saturated carboxylic acid and a carboxylic acid containing a carbon-carbon double bond (also known as unsaturated carboxylic acid) in an acid pickling process, the yellowing resistance of the composition can be improved, such that the yellowing index (YI) of a melt processed product is not significantly higher than that prior to the processing, thus the YI is lower than that of the existing EVOH melt processed product.

According to a preferred embodiment of the invention, a weight ratio of the mono-saturated carboxylic acid and the carboxylic acid containing a carbon-carbon double bond is 1:0.1-1, preferably 1:0.4-0.7.

In the invention, the content of mono-saturated carboxylic acid, phosphate radical, and carboxylic acid containing a carbon-carbon double bond was detected by an ion chromatography. The specific testing method was as follows: the EVOH sample was crushed and passed through a 100 mesh sieve, 10 g of sample and 50 ml of deionized water were weighted, and subjected to stirring and reflux extraction in water bath of 95° C. for 10 hours. The extracted solution was diluted 5 times (by volume) with deionized water, the testing was performed by using an ion chromatography, wherein the chromatographic column was Metrosep A Supp/250,4 the mobile phase was a mixed solution of Na₂CO₃ and NaHCO₃, the calibration fluid was an aqueous solution of sodium acetate.

Preferably, the mono-saturated carboxylic acid is contained in an amount of 50-2,000 ppm, more preferably 100-1,500 ppm, further preferably 200-800 ppm, relative to the mass of ethylene-vinyl alcohol copolymer; the carboxylic acid containing a carbon-carbon double bond is contained in an amount of 20-2,000 ppm, more preferably 50-1,000 ppm, further preferably 150-250 ppm, relative to the mass of ethylene-vinyl alcohol copolymer.

In the present invention, the carboxylic acid containing a carbon-carbon double bond may comprise one or more carboxyl, the carboxylic acid may comprise one or more carbon-carbon double bond, and further comprise one or more hydroxyl. The carboxylic acid containing a carbon-carbon double bond may comprise 3-10 carbon atoms, the carboxylic acid is preferably one or more selected from the group consisting of sorbic acid, 2-hexenoic acid, 3-hexenoic acid, butenedioic acid, vinylacetic acid, vinylpropionic acid, vinylglycolic acid and cinnamic acid.

The mono-saturated carboxylic acid may be a variety of materials containing one carboxyl —COOH and an unsaturated carbon-carbon double bond, preferably a mono-saturated carboxylic acid having 1-8 carbon atoms, more preferably 1-5 carbon atoms, such as one or more of formic acid, acetic acid, propionic acid, butyric acid and valeric acid.

The present inventors have also surprisingly discovered that the heat resistance of the prepared EVOH resin composition can be greatly improved by adding the element potassium after contacting with an acid, and controlling the mass ratio of element sodium to element potassium within a specific range of 0.1:1 to 1:1, preferably 0.2:1 to 0.8:1, more preferably 0.2:1 to 0.5:1. It has been demonstrated by experiments that by controlling the content of element potassium within the above range, the initial decomposition temperature of EVOH resin composition can be increased to 380-390° C., the maximum decomposition temperature can be increased to 420° C. or more, and the ethylene-vinyl alcohol copolymer can be adapted to the process requirement for a higher processing temperature.

The better effects can be obtained by controlling the content of element sodium within a certain range. The total amount of element sodium and element potassium is preferably 100-3,000 ppm, more preferably 200-2,000 ppm, further preferably 800-1,200 ppm, relative to the mass of ethylene-vinyl alcohol copolymer.

In the present invention, the contents of element potassium and element sodium were measured by an Inductively Coupled Plasma Atomic Emission Spectrometer (ICP-0ES). The specific testing method was as follows: an EVOH sample was crushed and passed through a 500 mesh sieve, 10 g of sample and 50 ml of ion exchange water were weighted, and subjected to stirring and reflux extraction in water bath of 95° C. for 10 hours. The extracted solution was diluted 5 times (by volume) with ion exchange water, and tested using an ICP-0ES.

Preferably, the element potassium is present in an ionic form, more preferably in the form of a potassium salt, and further preferably the potassium salt is potassium carbonate and/or potassium bicarbonate. Potassium carbonate and potassium bicarbonate can achieve superior resistance to high temperature yellowing than the inorganic potassium salt (e.g., potassium nitrate, potassium phosphate, potassium diphydrogen phosphate, dipotassium phosphate, potassium sulfate, potassium chloride) and the organic potassium salts (e.g., potassium acetate, potassium formate).

According to a preferred embodiment of the invention, the EVOH resin composition comprises an ethylene-vinyl alcohol copolymer, a carboxyl-containing material, a potassium salt and a sodium salt, wherein the carboxyl-containing material contains an acetic acid and carboxylic acid containing a carbon-carbon double bond, wherein the carboxylic acid containing a carbon-carbon double bond comprises one or more selected from the group consisting of sorbic acid, 2-hexenoic acid, 3-hexenoic acid, butenedioic acid, vinylacetic acid, vinylpropionic acid, vinylglycolic acid and cinnamic acid; the content of acetic acid is 50-2,000 ppm by mass relative to the ethylene-vinyl alcohol copolymer; the content of carboxylic acid containing a carbon-carbon double bond is 20-2,000 ppm by mass relative to the ethylene-vinyl alcohol copolymer; the total amount of potassium salt and sodium salt (i.e., the total amount of potassium ions and sodium ions contained in the potassium salt and sodium salt) is 200-3,000 ppm by mass relative to the mass of ethylene-vinyl alcohol copolymer; and the mass ratio of sodium ions contained in the sodium salt to potassium ions contained in the potassium salt is 0.1:1 to 1:1.

In order to prevent the EVOH resin composition from coloring during the melt molding process, according to a preferred embodiment of the present invention, the EVOH resin composition may further comprise an element boron and/or an element phosphorus. The element boron may be any boron-based compound, such as boric acid, borate esters, borate; preferably one or more selected from the group consisting of orthoboric acid (i.e., commonly known boric acid), metaboric acid, tetraboric acid, sodium metaborate, potassium metaborate, sodium tetraborate, sodium pentaborate, lithium borate, borax, trimethyl borate, triethyl borate, most preferably boric acid.

Preferably, the content of element boron calculated in terms of boric acid H₃BO₃ is 50-1,000 ppm, preferably 300-500 ppm, relative to the mass of ethylene-vinyl alcohol copolymer. By arranging the content of element boron within this range, the heat resistance yellowing resistance of an EVOH resin composition are greatly improved, and the adverse effect on the melt-processing process can be effectively avoided.

It is further preferred that the EVOH resin composition further comprises a phosphorus compound in an amount of 200-1,000 ppm, preferably 500-800 ppm calculated in terms of phosphoric acid H₃PO₄. The phosphorus compound may be various phosphates such as alkali metal salts of phosphoric acid, alkaline earth metal salts of phosphoric acid; in particular, the phosphorus compound may be one or more of potassium phosphate, sodium phosphate, ammonium phosphate, diammonium phosphate, ammonium dihydrogen phosphate, dipotassium phosphate, disodium phosphate, potassium dihydrogen phosphate, sodium dihydrogen phosphate. It should be noted that when the phosphorus compound is various potassium salt of phosphoric acid, the amount of potassium thereof is included in the content of element potassium in the composition.

In the present invention, the ethylene-vinyl acetate copolymer may be EVOH copolymer obtained by various specifications and processes, and preferably, the ethylene-vinyl acetate copolymer has a melt index (190° C., 2160 g) of 0.5-10 g/10 min.

The ethylene-vinyl acetate copolymer can be prepared with the conventional method in the prior art, for example, it may be prepared through the polymerization reaction; the solvent used in the polymerization reaction is an alcohol solvent, and the initiator used in the polymerization reaction is preferably an azo type initiator or a peroxide type initiator.

A second aspect of the present invention provides a preparation method of the ethylene-vinyl alcohol copolymer composition, the method comprises subjecting the ethylene-vinyl acetate copolymer obtained from the polymerization reaction to an alcoholysis with an alkali metal hydroxide and molding granulation, followed by a water scrubbing and an acid pickling sequentially, characterized in that the acid used in the acid pickling comprises a mono-saturated carboxylic acid and a carboxylic acid containing a carbon-carbon double bond.

The water scrubbing and acid pickling reduce the content of element sodium to 50-2,000 ppm.

In general, the acid pickling is performed by formulating the acid into an aqueous solution with a certain concentration, followed by contacting with granules of the ethylene-vinyl acetate copolymer. Typically, the weight of acid pickling solution is 2-5 times of the weight of the granules of ethylene-vinyl acetate copolymer.

Preferably, the mono-saturated carboxylic acid is used in an amount of 0.001-0.05 parts by weight, preferably 0.005-0.03 parts by weight, and the carboxylic acid containing a carbon-carbon double bond is used in an amount of 0.001-0.015 parts by weight, preferably 0.001-0.01 parts by weight, relative to 1 part by weight of an ethylene-vinyl alcohol copolymer.

When the alkali metal hydroxide used for alcoholysis is sodium hydroxide, the temperature decomposition resistance of the resin product can be improved by further adding a potassium source after the washing process, such that the prepared EVOH resin composition comprises an element potassium. Preferably, the potassium source is a potassium salt, and further preferably the potassium salt is one or more selected from the group consisting of potassium carbonate, potassium bicarbonate, potassium phosphate, potassium hydrogen phosphate, potassium dihydrogen phosphate and dipotassium hydrogen phosphate.

Preferably, the dosage of potassium source is 0.001-0.003 times of the mass of ethylene-vinyl alcohol copolymer.

According to a preferred embodiment of the present invention, the method further comprises adding a phosphorus-containing compound and/or a boron-containing compound to the ethylene-vinyl acetate copolymer after the acid pickling process.

Preferably, the boron-containing compound is added in an amount such that the content of element boron calculated in terms of boric acid H₃BO₃ is 50-1,000 ppm, more preferably 300-500 ppm, relative to the mass of ethylene-vinyl alcohol copolymer.

Preferably, the phosphorous-containing compound is added in an amount such that the content of element phosphorus calculated in terms of H₃PO₄ is 200-1,000 ppm, more preferably 500-800 ppm, relative to the mass of ethylene-vinyl alcohol copolymer.

The boron source and/or the phosphorous source may be added together with the potassium source, or may be added sequentially to obtain a composition containing element potassium, element boron and element phosphorous. The manner of adding the potassium salt, the boron-containing compound, and the phosphorus-containing compound is not particularly limited herein, it is preferable that the compounds are dissolved with water, the solution is then added into the ethylene-vinyl alcohol copolymer and mixed uniformly. The concentration of said solution is not particularly limited herein, it may be various concentrations as long as the potassium salt, the boron-containing compound and the phosphorus-containing compound can be loaded onto the ethylene-vinyl alcohol copolymer. Since the ethylene-vinyl alcohol copolymer has a certain pore structure, the potassium salt, the boron-containing compound and the phosphorus-containing compound can be loaded onto the ethylene-vinyl alcohol copolymer by using a saturated impregnation method, the solvent is then removed by drying, such that the ethylene-vinyl alcohol copolymer composition is prepared.

The kinds of boron source, phosphorous source, potassium source are as described above.

Various methods known in the prior art may be used for preparing the ethylene-vinyl acetate copolymer through the polymerization reaction, the methods may be solution polymerization method, emulsion polymerization method or suspension polymerization method, the solution polymerization method is preferred. Preferably, the solvent used in the polymerization reaction is an alcohol solvent. The alcohol solvent may be an alcohol containing 1-4 carbon atoms, such as methanol, ethanol, propanol, ethylene glycol, n-butanol, t-butanol, or a mixed solvent of the two alcohols, or the alcohol comprising said alcohol as the main ingredient and further comprising small amount of other ingredients.

The initiator used in the polymerization reaction may be an azo type initiator or a peroxide type initiator.

Further, the azo type initiator includes an oil-soluble initiator, such as azobisisobutyronitrile, azobisisovaleronitrile, 1-((cyano-1-methylethyl)azo)formamide, 1,1′-azobis(4-cyclohexane carbonitrile), dimethyl 2,2′-azobis(2-methylpropionate).

Further, the peroxide type initiator includes an organic peroxide (e.g., benzoyl peroxide, tert-butyl benzoyl peroxide ester, methyl ethyl ketone peroxide, diisobutyryl peroxide, tert-amyl peroxydecanoate, bis (4-tert-butylcyclohexyl) peroxydicarbonate, tert-amyl peroxypivalate, tert-butyl peroxyacetate, dibutyl peroxydicarbonate) or an inorganic peroxide (e.g., hydrogen peroxide, ammonium persulfate, potassium persulfate).

Further, the initiator comprises an organic peroxy-based initiator.

Further, the proportioning relations in parts by mass are as follows: 10-40 parts of solvent, 60-200 parts of vinyl acetate monomer, 0.01-0.3 parts of initiator, and 5-60 parts of ethylene monomer.

Furthermore, the proportioning relations in parts by mass are as follows: 10-35 parts of the solvent, 80-150 parts of the vinyl acetate monomer, 0.03-0.2 parts of the initiator, and 20-40 parts of the ethylene monomer.

The alcoholysis and the molding granulation processes are generally known among those skilled in the art, the content will not be repeated herein.

The invention will be further described in detail below with reference to the examples.

The contents of sodium and potassium ions were measured with the following method: an EVOH sample was crushed and passed through a sieve, 10 g of sample and 50 ml of ion exchange water were weighted, and subjected to stirring and reflux extraction in water bath of 95° C. for 10 hours. The extracted solution was diluted 5 times (by volume) with ion exchange water, and tested using an ICP-0ES.

The contents of the monocarboxylic acid, the carboxylic acid containing a carbon-carbon double bond and the phosphate radical were measured with the following method: the sample was crushed and passed through a 100 mesh sieve, 10 g of sample and 50 ml of deionized water were weighted, and subjected to stirring and reflux extraction in water bath of 95° C. for 10 hours. The extracted solution was diluted 5 times (by volume) with deionized water, the testing was performed by using an ion chromatography, wherein the chromatographic column was Metrosep A Supp/250,4 the mobile phase was a mixed solution of Na₂CO₃ and NaHCO₃, the calibration fluid was an aqueous solution of sodium acetate.

The testing method of element boron was as follows: 100 g of sample was weighted, it was ashed in a muffle furnace, then the ash was dissolved in 200 ml of aqueous nitric acid solution with a concentration of 0.01 equivalent, the content of element boron was analyzed by using an atomic absorption spectrum, the content was converted into the weight of boric acid.

The initial decomposition temperature and the maximum decomposition temperature were measured with the following methods: a thermogravimetric analyzer was used, the temperature was raised from room temperature to 800° C. at a temperature-rise rate of 10° C./min in a nitrogen gas atmosphere; the temperature when 5% (w) of the sample was decomposed was denoted as the initial decomposition temperature T₀ (° C.), and the temperature when 50% (w) of the sample was decomposed was denoted as the maximum decomposition temperature T₁ (° C.).

The measuring method of the Yellowness Index (YI) was as follows: 10-15 g of the sample was weighted, the initial yellowness index and the yellowness index (YI) after 0.5-hour thermal treatment at 210° C. of the sample were tested with a colorimeter. A smaller value of YI indicated a lower value of yellowness.

Unless otherwise specified in the present invention, the parts are referred to as parts by mass.

### Example 1

A. polymerization: 16 parts of methanol, 80 parts of vinyl acetate, 0.01 parts of azobisisobutyronitrile were added into a polymerization kettle provided with a stirrer, the ethylene was introduced to maintain the pressure in the polymerization kettle at 3.7 MPa, the polymerization reaction was performed at a temperature of 65° C. for 5 h, an ethylene-vinyl acetate copolymer solution was obtained. The ethylene and vinyl acetate monomers were removed by reducing the pressure and distillation to obtain an ethylene-vinyl acetate copolymer solution.
B. alcoholysis: the ethylene-vinyl acetate copolymer solution obtained in step A was adjusted to have a mass fraction of 40%, a sodium hydroxide-methanol solution (sodium hydroxide was used as a solute) with a concentration of 40 g/L was then added and subjected to alcoholysis, the sodium hydroxide-methanol solution is used in an amount such that a molar ratio of sodium hydroxide in the sodium hydroxide-methanol solution to vinyl acetate groups contained in the ethylene-vinyl acetate copolymer was 0.05:1, the reaction was performed for 4 hours till the completion of alcoholysis.
C. granulation: after the ethylene vinyl acetate copolymer was subjected to alcoholysis, the obtained ethylene vinyl alcohol copolymer solution passed through an extrusion device with a perforated plate and was extruded into an aqueous solution with a temperature of 5° C., the copolymer was precipitated and formed a strip shape, which was subsequently cut into granules in a conventional cutting pattern.
D. water scrubbing: the ethylene-vinyl alcohol copolymer granules were subsequently scrubbed in a kettle vessel provided with a stirring device by adding 5 times of water by mass, each time of water scrubbing was implemented for 2 hours, the water scrubbing was repeated for 2 times.
E. acid pickling: the ethylene-vinyl alcohol copolymer granules were washed in a kettle vessel provided with a stirring device by adding 5 times of water by mass, 0.015 parts by mass of propionic acid and 0.007 parts by mass of sorbic acid relative to the EVOH (1 part by mass) were added into the water scrubbing solution, in order to perform the acid pickling for 2 hours, the centrifugal dewatering was carried out after completion of the acid pickling process.
F. conditioning: the EVOH granules after centrifugal dewatering were then added with an aqueous solution comprising 0.0015 parts of potassium carbonate, 0.001 parts of boric acid and 0.001 parts of potassium dihydrogen phosphate relative to the EVOH (1 part by mass), mixed thoroughly and uniformly and subjected to the saturation impregnation, followed by drying treatment at 115° C. for 24 hours, the EVOH resin composition was prepared.

### Example 2-Example 10

The EVOH resin composition was prepared according to the method in Example 1, except that the kinds and used amounts of the monocarboxylic acids, the carboxylic acid containing an unsaturated carbon-carbon double bond, the phosphorus source, the boron sources and the potassium sources in steps E and F were as shown in Table 1, and the properties of the prepared EVOH resin composition were as shown in Table 2.

### Comparative Example 1-Comparative Example 3

The EVOH resin composition was prepared according to the method in Example 1, except that the kinds and used amounts of the monocarboxylic acids, the carboxylic acid containing an unsaturated double bond, and the potassium sources in steps E and F were as shown in Table 1, and the properties of the prepared EVOH resin composition were as shown in Table 2.

TABLE 1

| | Saturated | Unsaturated | | | |
|---|---|---|---|---|---|
| | carboxylic | carboxylic | Boron | Phosphorus | Potassium |
| | acid | acid | source | source | source |
| Example 1 | 0.015 parts of | 0.007 parts of | 0.001 parts of | 0.001 parts of | 0.0015 parts of |
| | propionic acid | sorbic acid | boric acid | monopotassium | potassium |
| | | | | phosphate | carbonate |
| Example 2 | 0.02 parts of | 0.007 parts of | 0.0008 parts of | 0.0008 parts of | 0.0017 parts of |
| | acetic acid | vinylpropionic | metaboric | phosphoric | potassium |
| | | acid | acid | acid | bicarbonate |
| Example 3 | 0.02 parts of | 0.005 parts of | 0.0006 parts of | 0.0012 parts of | 0.0007 parts of |
| | acetic acid | vinylacetic | boric acid | monopotassium | potassium |
| | | acid | | phosphate | carbonate |
| Example 4 | 0.02 parts of | 0.005 parts of | 0.0006 parts of | 0.0012 parts of | — |
| | acetic acid | vinylacetic | boric acid | monopotassium | |
| | | acid | | phosphate | |
| Example 5 | 0.02 parts of | 0.005 parts of | — | 0.0012 parts of | 0.0007 parts of |
| | acetic acid | vinylacetic | | monopotassium | potassium |
| | | acid | | phosphate | carbonate |
| Example 6 | 0.02 parts of | 0.005 parts of | 0.0022 parts of | 0.0012 parts of | 0.0007 parts of |
| | acetic acid | vinylacetic | boric acid | monopotassium | potassium |
| | | acid | | phosphate | carbonate |
| Example 7 | 0.02 parts of | 0.005 parts of | 0.0006 parts of | — | 0.0007 parts of |
| | acetic acid | vinylacetic | boric acid | | potassium |
| | | acid | | | carbonate |
| Example 8 | 0.015 parts of | 0.004 parts of | — | — | 0.002 parts of |
| | acetic acid | vinylpropionic | | | potassium |
| | | acid | | | carbonate |
| Comparative | 0.015 parts of | — | — | — | 0.002 parts of |
| Example 1 | acetic acid | | | | potassium |
| | | | | | carbonate |
| Example 9 | 0.015 parts of | 0.004 parts of | — | — | 0.0021 parts of |
| | acetic acid | butenoic acid | | | potassium |
| | | | | | bicarbonate |
| Comparative | 0.005 parts of | — | — | — | 0.0017 parts of |
| Example 2 | acetic acid | | | | potassium |
| | | | | | bicarbonate |
| Example 10 | 0.02 parts of | 0.004 parts of | — | — | 0.0025 parts of |
| | acetic acid | sorbic acid | | | potassium |
| | | | | | bicarbonate |
| Comparative | 0.005 parts of | — | — | — | 0.002 parts of |
| Example 3 | acetic acid | | | | potassium |
| | | | | | bicarbonate |

TABLE 2

| | | | | | | | | | Yellowness Index (YI) | |
|---|---|---|---|---|---|---|---|---|---|---|
| | | | | | | | | | Before | After |
| | Saturated | Unsaturated | | | | | | | the | the |
| | carboxylic | carboxylic | Na, | K, | B, | P, | T₀, | T₁, | thermal | thermal |
| | acid, ppm | acid, ppm | ppm | ppm | ppm | ppm | ° C. | ° C. | treatment | treatment |
| Example 1 | 300 | 200 | 300 | 610 | 500 | 200 | 390 | 423 | 5 | 15 |
| Example 2 | 400 | 200 | 180 | 900 | 400 | 400 | 395 | 432 | 5 | 14 |
| Example 3 | 400 | 180 | 240 | 730 | 300 | 500 | 392 | 425 | 6 | 13 |
| Example 4 | 400 | 180 | 240 | — | 300 | 500 | 380 | 398 | 9 | 18 |
| Example 5 | 400 | 180 | 240 | 730 | — | 500 | 382 | 400 | 8 | 19 |
| Example 6 | 400 | 180 | 240 | 730 | 1000 | 500 | 385 | 401 | 7 | 17 |
| Example 7 | 400 | 180 | 240 | 730 | 300 | — | 379 | 399 | 8 | 18 |
| Example 8 | 350 | 100 | 500 | 800 | — | — | 362 | 403 | 9 | 18 |
| Comparative | 350 | — | 750 | 800 | — | — | 290 | 364 | 18 | 34 |
| Example 1 | | | | | | | | | | |
| Example 9 | 300 | 120 | 600 | 900 | — | — | 350 | 390 | 12 | 22 |
| Comparative | 100 | — | 1200 | 700 | — | — | 301 | 370 | 15 | 32 |
| Example 2 | | | | | | | | | | |
| Example 10 | 400 | 100 | 400 | 1000 | — | — | 370 | 423 | 7 | 19 |
| Comparative | 100 | 20 | 1200 | 800 | — | — | 297 | 358 | 17 | 33 |
| Example 3 | | | | | | | | | | |

As can be seen from the data of Table 2 mentioned above, the thermal yellowing resistance of EVOH resin composition can be improved by adding a carboxylic acid containing a carbon-carbon double bond; in addition, both the heat resistance and the thermal yellowing resistance of EVOH resin composition can be improved by simultaneously controlling the content of potassium salt and sodium salt within a certain range.

Furthermore, it shall be comprehended that although the description is specified according to the embodiments, it is not the case that every embodiment contains only one independent technical solution, such a narrative mode of the description is adopted for the sake of clarity. Those skilled in the art shall regard the description as a whole, the technical solutions in the embodiments can be appropriately combined, thereby forming the other embodiments which are understandable for those skilled in the art.

1-16. (canceled)

17. An ethylene-vinyl alcohol copolymer composition, the composition includes an ethylene-vinyl alcohol copolymer, an alkali metal element and a carboxyl-containing material, wherein the carboxyl-containing material includes a mono-saturated carboxylic acid and a carboxylic acid containing a carbon-carbon double bond;
the alkali metal element is element potassium and element sodium, wherein a total amount of the element potassium and the element sodium is 100-3,000 ppm, relative to a mass of the ethylene-vinyl alcohol copolymer.

18. The composition according to claim 17, wherein a weight ratio of the mono-saturated carboxylic acid and the carboxylic acid containing a carbon-carbon double bond is 1:0.1-1.

19. The composition according to claim 17, wherein the mono-saturated carboxylic acid is contained in an amount of 50-2,000 ppm, relative to the mass of ethylene-vinyl alcohol copolymer; the carboxylic acid containing a carbon-carbon double bond is contained in an amount of 20-2,000 ppm, relative to the mass of the ethylene-vinyl alcohol copolymer.

20. The composition according to claim 17, wherein the carboxylic acid containing a carbon-carbon double bond comprises one or two carboxyl.

21. The composition according to claim 17, wherein the carboxylic acid containing a carbon-carbon double bond is one or more selected from the group consisting of sorbic acid, 2-hexenoic acid, 3-hexenoic acid, butenedioic acid, vinylacetic acid, vinylpropionic acid, vinylglycolic acid and cinnamic acid.

22. The composition according to claim 17, wherein the total amount of the element potassium and the element sodium is 800-1,200 ppm, relative to the mass of the ethylene-vinyl alcohol copolymer.

23. The composition according to claim 22, wherein the alkali metal element is element potassium and element sodium, wherein the total amount of the element potassium and the element sodium is 800-1,200 ppm, relative to the mass of the ethylene-vinyl alcohol copolymer.

24. The composition according to claim 23, wherein a mass ratio of the element sodium to the element potassium is 0.1:1 to 1:1.

25. The composition according to claim 24, wherein the mass ratio of the element sodium to the element potassium is 0.2:1 to 0.5:1.

26. The composition according to claim 17, wherein the composition further comprises element boron and/or element phosphorus; a content of the element boron calculated in terms of boric acid H₃B₃ is 50-1,000 ppm, and a content of the element phosphorus calculated in terms of H₃PO₄ is 200-1,000 ppm, relative to the mass of the ethylene-vinyl alcohol copolymer.

27. A preparation method of an ethylene-vinyl alcohol copolymer composition, the method comprises subjecting an ethylene-vinyl acetate copolymer obtained from a polymerization reaction to an alcoholysis with an alkali metal hydroxide and molding granulation, followed by a water scrubbing and an acid pickling sequentially, wherein an acid used in the acid pickling comprises a mono-saturated carboxylic acid and a carboxylic acid containing a carbon-carbon double bond.

28. The preparation method according to claim 27, wherein a weight ratio of the mono-saturated carboxylic acid and the carboxylic acid containing a carbon-carbon double bond is 1:0.1-1.

29. The preparation method according to claim 27, wherein the mono-saturated carboxylic acid is used in an amount of 0.001-0.05 parts by weight and the carboxylic acid containing a carbon-carbon double bond is used in an amount of 0.001-0.01 parts by weight, relative to 1 part by weight of the ethylene-vinyl alcohol copolymer.

30. The preparation method according to claim 27, wherein the carboxylic acid containing a carbon-carbon double bond comprises one or two carboxyl.

31. The preparation method according to claim 27, wherein the carboxylic acid containing a carbon-carbon double bond is one or more selected from the group consisting of sorbic acid, 2-hexenoic acid, 3-hexenoic acid, butenedioic acid, vinylacetic acid, vinylpropionic acid, vinylglycolic acid and cinnamic acid.

32. The preparation method according to claim 27, wherein the alkali metal hydroxide used for alcoholysis is sodium hydroxide, the method further comprises adding a potassium salt to the ethylene-vinyl acetate copolymer after the acid pickling process, the potassium salt is added in an amount such that a total amount of the element potassium and the element sodium is 100-3,000 ppm, relative to the mass of the ethylene-vinyl alcohol copolymer.

33. The preparation method according to claim 32, wherein the potassium salt is added in an amount such that a total amount of the element potassium and the element sodium is 800-1,200 ppm, relative to the mass of the ethylene-vinyl alcohol copolymer.

34. The preparation method according to claim 33, wherein the potassium salt is added in an amount such that a mass ratio of the element sodium to the element potassium is 0.1:1 to 1:1.

35. The preparation method according to claim 34, wherein the potassium salt is added in an amount such that the mass ratio of the element sodium to the element potassium is 0.2:1 to 0.5:1.

36. The preparation method according to claim 33, wherein the method further comprises adding a phosphorus-containing compound and/or a boron-containing compound to the ethylene-vinyl acetate copolymer after the acid pickling process; and/or the phosphorus-containing compound and the boron-containing compound are added in an amount such that a content of element boron calculated in terms of boric acid H₃BO₃ is 50-1,000 ppm, and a content of element phosphorus calculated in terms of H₃PO₄ is 200-1,000 ppm, relative to the mass of the ethylene-vinyl alcohol copolymer.
